(19) United States
(12) Patent Application Publication
(10) Pub. No.: US 2025/0273733 A1
(43) Pub. Date: Aug. 28, 2025

(54) IMPROVED SOLID-STATE IONIC CONDUCTING MATERIALS AND METHODS OF MAKING THE SAME

(71) Applicants: THE REGENTS OF THE UNIVERSITY OF COLORADO, A BODY CORPORATE, Denver, CO (US); THE REGENTS OF THE UNIVERSITY OF CALIFORNIA, Oakland, CA (US)

(72) Inventors: Chunmei BAN, Golden, CO (US); Wei ZHANG, Clover, SC (US); Stephen J. HARRIS, Walnut Creek, CA (US)

(21) Appl. No.: 18/858,283

(22) PCT Filed: Apr. 19, 2023
(86) PCT No.: PCT/US2023/065959

§ 371 Date: Oct. 18, 2024

Related U.S. Application Data
(60) Provisional application No. 63/332,627, filed on Apr. 19, 2022.

(51) Int. Cl. H01M 10/0562; H01M 10/0525

(52) U.S. Cl. CPC H01M 10/0562; H01M 10/0525; H01M 2300/0077

(57) ABSTRACT

Improved solid electrolyte materials and methods of treating solid electrolyte materials to yield improved solid electrolyte material are described. The improved solid electrolyte material includes one or more near surface regions to which compressive stress is applied via ion implantation in order to strengthen the solid electrolyte material against, e.g., anode material dendrite penetration. Methods of treating the solid electrolyte material include subjecting the solid electrolyte material to ion implantation to thereby create a first and second region having ions implanted therein. The ion fluence in the second region may be greater than the ion fluence in the first region.

### CROSS REFERENCE TO RELATED APPLICATIONS

This application claims priority to U.S. Provisional Patent Application No. 63/332,627, entitled “IMPROVED SOLID-STATE IONIC CONDUCTING MATERIALS AND METHODS OF MAKING THE SAME”, filed Apr. 19, 2022, the entirety of which is hereby concorporated by reference.

### STATEMENT REGARDING FEDERALLY SPONSORED RESEARCH

This invention was made with government support under grant number DE-AC02-05CH11231 awarded by the U.S. Department of Energy. The government has certain rights in the invention.

### TECHNICAL FIELD

The present application relates to solid-state ionic conducting materials, such as solid electrolyte materials that may be used in, e.g., Li-ion batteries. More specifically, the present application relates to solid-state ionic conducting materials and methods of making the same wherein a region of the material, such as a near-surface region, is placed under residual compressive stress to thereby strengthen the material.

### BACKGROUND

Lithium-ion battery technology has made great progress in the last two decades such that Li-ion batteries are now widely used in a variety of different industries, including but not limited to the electric vehicle industry. However, the liquid organic electrolyte solvents used in some commercial lithium-ion batteries are reactive, hygroscopic, and highly flammable, and therefore present dangers to manufacturers and users.

As a result, some focus has shifted recently to the use of solid-state electrolytes in order to reduce or eliminate flammability problems associated with liquid organic electrolyte solvents. The use of solid electrolytes can also allow for the use of metal anodes in batteries, which can beneficially increase energy density and battery cycle life. For example, the use of Li or Na metal anodes could provide a substantial increase in the gravimetric and volumetric energy density for batteries.

However, the use of metal anodes in conjunction with solid electrolytes may present other issues. For example, dendrites that grow from Li or Na metal anodes can penetrate into the solid electrolyte material, which can induce mechanical fracture in the solid electrolyte material. This phenomenon is shown in FIG. 1, wherein a Li dendrite 110 that extends from Li anode 100 works its way through the solid electrolyte 120, typically along grain boundaries present in the solid electrolyte 120. Extensions from the primary dendrite 110 can create further cracks in the solid electrolyte 120. In addition to the grain boundaries shown in FIG. 1, dendrite penetration can also occur due to the presence of, e.g., contaminants, precipitates, and other heterogeneities in the solid electrolyte. The likely existence of residual tensile stress in at least some locations in the solid electrolyte further facilities the formation of cracks. Tensile stress may be present in the solid electrolyte due to, e.g., the presence of heterogeneities, or due to machining or polishing. Regardless of the specific reason or reasons for which they are formed, mechanical fractures such as those shown in FIG. 1 mechanically weaken the solid electrolyte material and can lead to a short circuit, such as if a dendrite grows through the solid electrolyte and contacts the cathode, which will quickly or eventually lead to thermal runaway and battery failure.

Current strategies used to try and address this problem, such as surface coatings, require surface chemistry stability against reduction and interaction with the metal of the anode, and thus can impede and/or degrade battery performance. Additionally, these strategies may require near-conformal contact between the anode and the solid electrolyte, which, practically speaking, is difficult if not impossible to achieve unless high external stack pressures are used. However, this is not practical when such high pressures are applied across cells that are large enough to be relevant to, e.g., electric vehicles.

To date, there are no known commercially available high-capacity rechargeable Li metal or Na metal batteries that operate at current densities comparable to those in liquid electrolytes, in significant part because of the dendrite penetration problem described previously.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a method of treating a solid electrolyte material to introduce residual compressive stress to a surface region of the solid electrolyte material generally includes the steps of subjecting the solid electrolyte material to ion implantation by accelerating ions towards a surface of the solid electrolyte at a first ion energy and a first ion fluence; and, from the ion implantation, implanting ions in the solid electrolyte material in a first region and a second region, wherein the first region extends from the surface of the solid electrolyte material to a first depth, and the second region extends from a second depth to a third depth. The implanted ions in the first region and second region introduce a surface residual compressive stress to the solid electrolyte material.

In some embodiments, a modified solid electrolyte material having residual compressive stress introduced to a surface region thereof includes a solid electrolyte material having a first surface; a first region within the solid electrolyte material extending from the first surface to a first depth, the first region having a first ion fluence; and a second region within the solid electrolyte material extending from a second depth to a third depth, the second region having a second ion fluence. The second and third depths are greater than the first depth and the second ion fluence can be greater than the first ion fluence.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including preferred embodiments, are described with reference to the following figures, wherein like reference numerals refer to like parts throughout the various views unless otherwise specified.

FIG. 1 is an illustration of an anode/solid electrolyte interface exhibiting dendrite penetration according to the prior art.

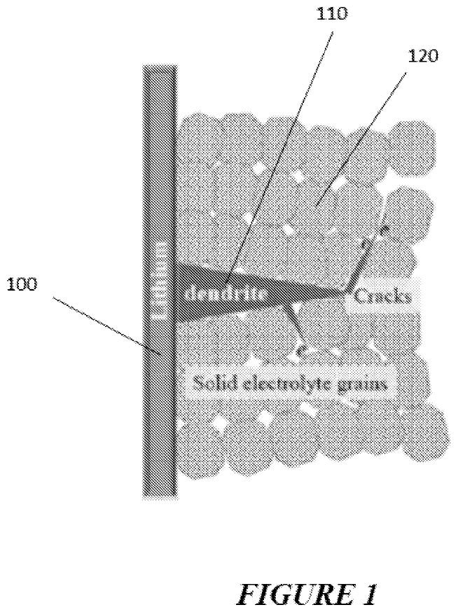

FIG. 2 is an illustration of an anode/solid electrolyte interface wherein the solid electrolyte is under compressive stress in accordance with various embodiments described herein.

FIG. 3 is an illustration of the process of applying ion implantation to the near surface region of a solid electrolyte in accordance with various embodiments described herein.

FIG. 4 is an illustration of a solid electrolyte material having two ion implanted regions configured in accordance with various embodiments described herein.

FIG. 5 is a series of graphs showing experimental data for solid electrolyte materials treated in accordance with various embodiments described herein.

FIGS. 6 are SEM images of pristine solid electrolyte material and solid electrolyte material treated in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

This Detailed Description focuses primarily on embodiments where the solid-state ionic conducting material is a solid electrolyte material suitable for use in batteries. However, it should be appreciated that the solid-state ionic conducting material described herein is not limited to solid electrolyte material or to applications in batteries. This Detailed Description also focuses primarily on instances of treating a near-surface region of the solid-state ionic conducting material. However, it should be appreciated that any region within the material, including regions that extend to various surfaces of the material, can be treated per the methods described herein, to the extent that such treatment creates similar benefits from introducing residual compressive strength into the material. In one non-limiting example, it is contemplated that the solid-state ionic-conducting material may be extremely thin (e.g., as thin as 25 microns), in which case an embodiment may call for the entirety of the material being treated according to the methods described herein.

Described herein are various embodiments of methods for treating solid electrolyte materials to thereby increase the strength of the solid electrolyte material. For example, the methods described herein may result in the solid electrolyte material becoming more resistant to penetration by metal dendrites and to the formation of cracks in the solid electrolyte material that may result from, e.g., dendrite penetration. Furthermore, as shown in experimental data described herein, the methods for strengthening the solid electrolytes described herein do not significantly impede the diffusivity of ions through the solid electrolyte material. Improved solid electrolyte materials formed from the methods described herein are also described in the present application.

With respect to methods for treating solid electrolyte material to thereby strengthen the solid electrolyte material, the methods described herein generally include providing a solid electrolyte material having a near surface region at a first surface of the solid electrolyte, subjecting the solid electrolyte material to ion implantation at prescribed operation parameters, and implanting ions into one or more regions within the solid electrolyte material. The implanted ions induce a surface residual compressive stress in the solid electrolyte material. The residual compressive stress is the stress that remains after all external pressures are removed; it is a property of the material. The creation of residual compressive stress in the one or more regions will generally impede the penetration of anode material into the solid electrolyte material due to the difficulty of opening a crack into a material that is in compression. In some embodiments, inducing a residual compressive stress in one or more region of the solid electrolyte may also close preexisting cracks present in the solid electrolyte.

The methods described herein are generally applicable to any type of solid electrolyte material. Non limiting examples include glass, ceramic and polymeric materials. In some embodiments, the solid electrolyte material is a ceramic solid electrolyte material, though other solid electrolyte materials may also be used. Exemplary, though non-limiting, solid electrolyte materials suitable for use in the technology described herein include Li₇La₃Zr₂O₁₂ (LLZO), Na₃Zr₂Si₂PO₁₂ (NASICON), Li₆PS₅Br, Li_{1.3}Al_{0.3}Ti_{1.7}(PO₄)₃ (LISICON), Li₃PO₄, and Li_{2.94}PO_{3.50}N_{0.31} (LIPON). Variations of these materials, including variations in which one or more additional elements are incorporated therein and/or the number of atoms for each element is adjusted, can also be used. For example, a suitable variation on LLZO that can be used is Li_{6.4}La₃Zr_{1.4}Ta_{0.6}O₁₂. In some embodiments, the ionic conductivity of the solid electrolyte material used is in the range of from about 0.1 to 1.0 mS/cm. In some embodiments, different operating parameters with respect to ion implantation may be used for different solid electrolyte materials.

Generally speaking, the methods described herein and used for inducing residual compressive force in the solid electrolytes is carried out in such a way that one or more regions relatively close to the surface of the solid electrolyte are implanted with ions to thereby introduce residual compressive forces to these regions. The added compressive stress enables a more reversible plating/stripping process in the solid electrolyte material and suppresses dendrite propagation in solid electrolytes, thus increasing the CCD up to a factor of 4 (1.2 mA/cm² vs. 0.3 mA/cm²) without any further treatment.

In some embodiments, any region or regions put under residual compressive stress are in the near surface region of the solid electrolyte material. In some embodiments, the near surface area is considered the area extending from a first surface of the solid electrolyte (typically the surface abutting the anode material) to a depth of 6 μm away from the first surface, although deeper treatments are not excluded. The ion implantation treatment will also generally be applied to the entire length and width of the first surface and near surface region or regions of the solid electrolyte material.

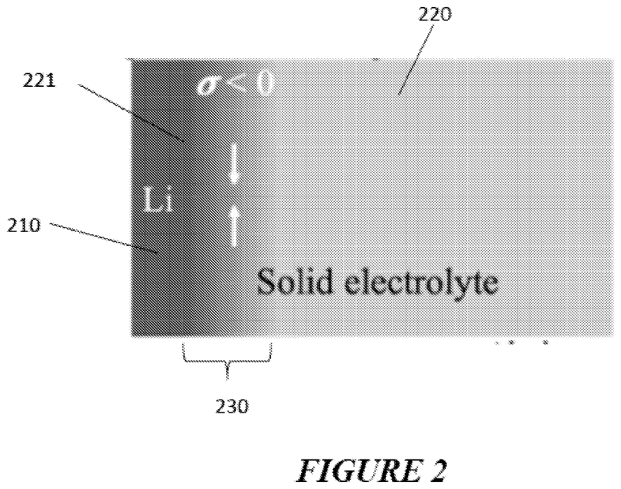

FIG. 2 generally illustrates an embodiment where one of the treated regions extends from the surface of the solid electrolyte to a first depth (e.g., 1 μm). A lithium metal anode 210 abuts a solid electrolyte 220 at a first surface 221 of the solid electrolyte 220. The near surface region 230 extends from the first surface 221 to a depth of, e.g., 1 μm from the first surface 221. The arrows shown in FIG. 2 denote that this near surface region 230 is in a state of residual compressive stress by virtue of ion implantation in this region, the compressive residual stress thereby inhibiting and preventing the ability of Li dendrites to grow from the Li anode 210, penetrate the first surface 221, and extend into the solid electrolyte 220. This growth of dendrite is restricted by, e.g., compressing grain boundaries or surface imperfections or the like into which Li dendrites might otherwise grow.

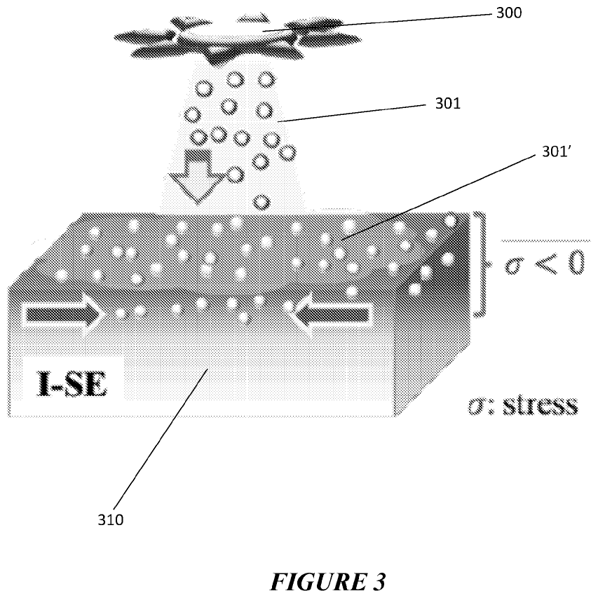

As noted previously, treatment of the solid electrolyte material to put one or more regions into compressive residual stress generally includes subjecting the solid electrolyte material to ion implantation. FIG. 3 provides a general illustration of ion implantation, wherein foreign ions 301 from an ion source 300 are accelerated at high energies at the surface of the solid electrolyte 310. The ions 301 penetrate the solid electrolyte 310 and become embedded ions 301′. As shown in FIG. 3, the embedded ions 301′ are located within a region of the solid electrolyte 310 extending from the surface of the solid electrolyte 310 to a first depth within the solid electrolyte 310. Because of the embedded ions 301′, this region is put under residual compressive stress, as noted by o in FIG. 3.

Energetic implanted ions suitable for use in ion implantation include, but are not limited to, transition-metal ions, halide ions, rare-gas ions, alkaline earth ions, and alkali ions such as lithium or sodium. In some embodiments, fluorine ions are used. Implantation of ions can modify the surface structure, leading to new mechanical properties of solid electrolytes. Thus, a large number of chemical, structural, and physical states can be created via ion implantation, including metastable non-equilibrium states, for nano/mesoscale tailoring of the surface structure of solid electrolytes.

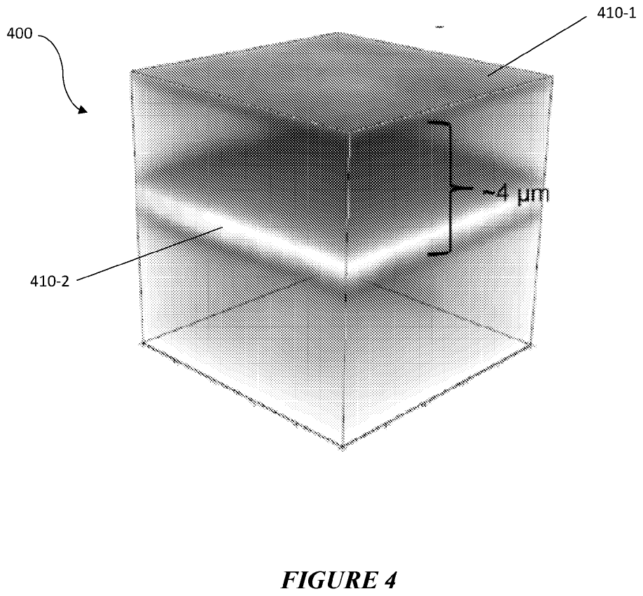

While FIG. 3 provides an illustration wherein a solid electrolyte material has ions implanted in a single region within the solid electrolyte material, some embodiments of the technology described herein involve multiple distinct regions within the solid electrolyte being embedded with ions. In some embodiments, two distinct regions within the solid electrolyte are embedded with ions. FIG. 4 illustrates this embodiments, wherein solid electrolyte 400 has two distinct regions 410-1 and 410-2 where ions are implanted as a result of ion implantation.

As shown in FIG. 4, first region 410-1 extends from the surface of the solid electrolyte 400 to a first depth in a similar fashion to the embodiment shown in FIG. 3. The first depth can be any suitable distance away from the surface, though in some embodiments, the first depth is relatively close to the surface such that the first region is relatively thin. In some embodiments, the first depth is 1 μm or less away from the surface, such as 0.75, 0.5 μm, or 0.25 μm from the first surface.

The second region 410-2 having ions implanted therein will generally be a distinct region from first region 410-1 (i.e., there is no overlap between first region 410-1 and second region 410-2), and furthermore, there is typically a gap between the first region 410-1 and second region 410-2 (i.e., the first region 410-1 does not contact the second region 410-2). The gap or area between the first region 410-1 and 410-2 generally has no or a negligible amount of ions implanted therein, wherein negligible means that no appreciable residual compressive stress results from the small amount of ions that may be implanted in this gap region. With respect to region 410-2, this region generally extends from a second depth to a third depth, wherein the second depth is greater than the first depth, and the third depth is greater than the first depth and the second depth. The specific depth measurements of the second depth and third depth are not generally limited. In some embodiments, the second depth is within a range of from about 2 μm to about 5 μm, such as from about 2.5 μm to about 3.5 μm, or about 4 μm, while the third depth is within a range of from about 3 μm to about 6.5 μm, such as from about 4 μm to about 4.5 μm, or about 6.5 μm. The specific depth measurements for the second region may be dependent on factors such as the material of the solid electrolyte and the operating parameters of the ion implantation used. For example, when the solid electrolyte is Li₆PS₅Br, the second region may extend from a second depth of about 4.5 μm to a third depth of about 6 μm, while solid electrolyte materials such as LLZO, NASICON, LISICON, LIPON may have a second region extending from a second depth of about 2.5 μm to a third depth of about 4.5 μm, or from 3.5μm to about 4.5 μm.

Each region of implanted ions within the solid electrolyte material will have a general density of ions. This ion density can be measured via atomic percentage, wherein atomic percentage is calculated by multiplying the ion fluence by the depth of the region and dividing this value by the total atoms per formula of the solid electrolyte material. For example, a version of the solid electrolyte material LLZO may have the formula Li_{6.4}La₃Zr_{1.4}Ta_{0.6}O₁₂, in which case the total atoms per this formula is 23.4. In some embodiments, the atomic % in the first region is within the range of 0.01 to 0.09 atomic %, such as from about 0.01 to about 0.05 atomic %, and the atomic % in the second region is within the range of about 0.05 to about 0.3 atomic %, such as 0.15 atomic %. Within each region, but especially within the second region, there may be variable ion density, with the density generally increasing from the second depth to a midpoint in the second region until a peak density is reached, followed by a decrease in the ion density from the midpoint to third depth. In such embodiments, the density measurement (e.g., atomic percent) may be calculated by integrating under a curve on a graph showing ion fluence versus depth and then dividing this value by the total atoms per formula. In some embodiments, the total number of ions in an implanted region such as the second region may be in the order of 10¹⁵ ions. The atomic values provided previously with respect to the first and second regions can be based on this method of calculation.

The energy used in the ion implantation step to bombard ions at the solid electrolyte material and thereby embed the ions into the solid electrolyte is one operating parameter than can be adjusted to adjust the location of the second region. Generally speaking, higher energies can result in deeper implantation, though many other factors (including, e.g., the density of the solid electrolyte material) also play a role in determining the depth of the second region. In some embodiments, an energy within the range of from about 50 KeV to about 6 MeV is used to obtain a second region in the depths described previously. Energy can be tuned to introduce residual compressive stress at different depths. For example, when using an energy of 6 MeV, F ions can be implanted in to LLZO with a depth in the range of from 3 μm to 4 μm, which thereby results in a compressive stress concentrated in the range of from 3 μm to 4 μm from the surface of the solid electrolyte. If a lower energy is used, the region of ion implantation will be closer to the surface.

The fluence of the beam of ions accelerated at the solid electrolyte material as well as the duration of time during which ions are accelerated at the solid electrolyte may impact the density of ions implanted in the ion implanted regions. In some embodiments, a fluence of between about 5,000 ions/cm² and about 30,000 ions/cm², such as from about 5,000 ions/cm² to about 15,000 ions/cm² or from about 16,000 ions/cm² to about 30,000 ions/cm², can be used when conducting ion implantation. The duration of the ion implantation is generally not limited, though in some embodiments, the ion implantation is carried out for a time period in the range of from about 0.5 to 2 hours.

A benefit of ion implantation as used in the embodiments described herein is that the chemical identity, acceleration velocity, and depth profile of the ions can be controlled by varying operation parameters of the ion implantation. The crystallinity of the implanted material and the stress level in the solid electrolyte can also be controlled. With respect to chemical identify, ion implantation may beneficially change the chemical identity of the treated region. For example, the addition of fluorine ions into the treated area as part of an ion implantation treatment may make the surface of the solid electrolyte more stable and less reactive to air environments and metal anode materials.

Generally speaking, an aim of the ion implantations methods described herein is to strengthen (i.e., increase the fracture toughness of) the solid electrolyte without deteriorating its performance as an electrolyte. Specifically, the ion implantation used to apply compressive stress to the solid electrolyte should not significantly impede ion transport through the solid electrolyte. Those of ordinary skill in the art have previously assumed that the addition of compressive stress to the solid electrolyte would inherently significantly decrease ion transport through the solid electrolyte. However, with respect to the techniques described herein (i.e., ion implantation), molecular dynamics calculations have been run showing that very high residual compressive stresses applied to a solid electrolyte (e.g., up to 10 GPa) only modestly effect ion transport kinetics, which is a surprising and counterintuitive finding.

For techniques in which compressive stress is applied to the solid electrolyte, the specific amount of compressive stress applied is generally not limited. In some embodiments, the amount of compressive stress applied to the solid electrolyte may be in the range of from several hundred MPa to 10 GPa or more, but even lower stresses may be beneficial.

In some embodiments, various surface treatments may be carried out prior to treating the solid electrolyte material to apply compressive stress thereto. In one non-limiting example, the surface of the solid electrolyte may be polished to remove surface contaminants prior to treating the solid electrolyte with ion implantation.

In addition to strengthening the solid electrolyte against dendrite penetration, the introduction of compressive residual surface stresses to the solid electrolyte as described herein is expected to make the solid electrolyte less brittle and, thus, easier to handle in a commercial environment.

While the present description has focused primarily on the treatment of solid electrolytes for use in batteries, it should be appreciated that the technology described herein is not limited to the battery industry, and will have applicability across various industries.

### EXPERIMENTAL DATA

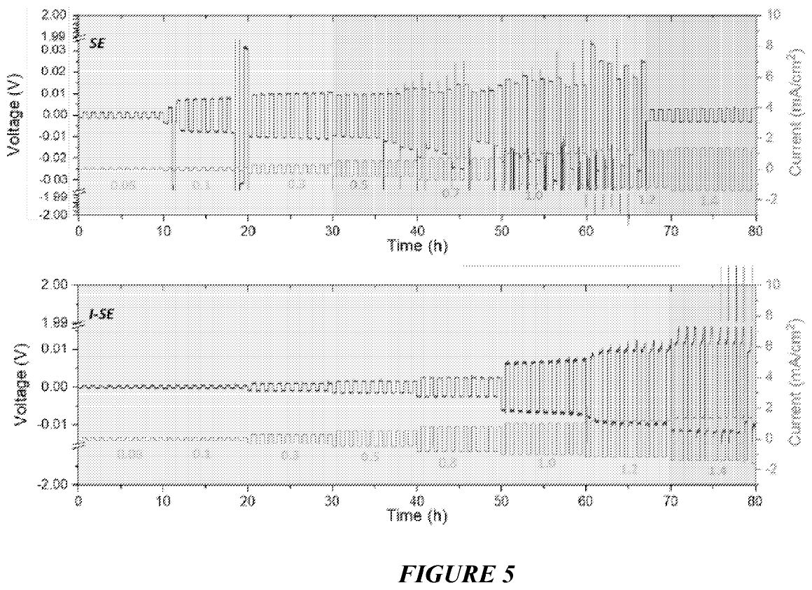

Experiments comparing a pristine LLZO solid electrolyte with a LLZO solid electrolyte treated in accordance with embodiments described herein were performed. The experimental results confirm that the ion-implanted SEs, with a conductivity of ˜1.0 mS/cm, enable Li stripping/plating at a much higher current density (up to 1.2 mA/cm²) than for the pristine SEs (less than 0.3 mA/cm²). As shown in FIG. 5, at low current densities (left shaded regions) ohmic behavior is observed in the galvanostatic cycling of stripping/plating. With increased current densities, Li stripping/plating deviates from ohmic behavior (middle shaded regions), due to morphological degradation caused by voids at the Li-SE interface. At higher current densities, Li dendrites from morphologically unstable interfaces leading to short circuits, indicated by a significant drop in the potential (right shaded regions). The ion implanted-LLZO SE can tolerate high-current-density without causing a short circuit.

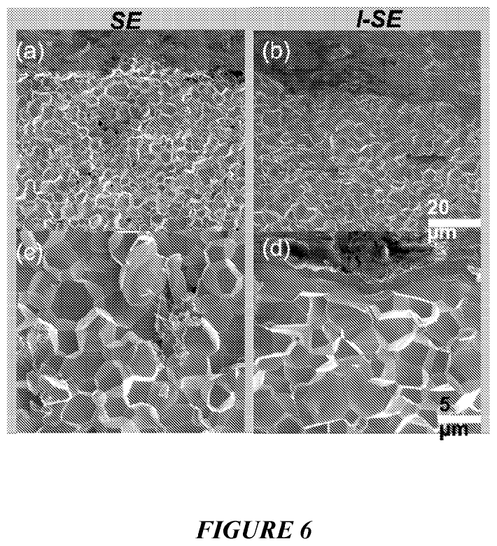

FIG. 6 shows the scanning electron microscopy (SEM) images shows extensive dendrite penetration ((a) and (c)) in the pristine solid electrolyte sample (SE) after stripping/plating at 1 mA/cm², while no Li deposition is observed ((b) and (d)) in the implanted regions of the SE (I-SE).

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/we claim:

1. A method of treating a solid electrolyte material to introduce residual compressive stress to a surface region of the solid electrolyte material, comprising:
subjecting the solid electrolyte material to ion implantation by accelerating ions from an ion source towards a surface of the solid electrolyte under a first ion energy and a first ion fluence;
from the ion implantation, implanting ions in the solid electrolyte material in a first region and a second region, wherein the first region extends from the surface of the solid electrolyte material to a first depth, and the second region extends from a second depth to a third depth;
wherein the implanted ions in the first region and second region introduce a surface residual compressive stress to the solid electrolyte material.

2. The method of claim 1, wherein the ions accelerated from the ion source towards the solid electrolyte material and implanted in the first and second regions of the solid electrolyte material are selected from the group consisting of: transition-metal ions, alkaline earth ions, halide ions, rare-gas ions, and alkali ions.

3. The method of claim 1, wherein the first ion energy is in a range of from about 50 KeV to about 6 MeV.

4. The method of claim 1, wherein the first ion fluence is in a range of from about 5,000 to about 15,000 ions/cm².

5. The method of claim 1, wherein the first ion fluence is in a range of from about 16,000 to about 30,000 ions/cm².

6. The method of claim 1, wherein the first depth is about 1 μm.

7. The method of claim 1, wherein the second depth is within a range of from about 2.5 μm to about 3.5 μm and the third depth is within a range of from about 4 μm to about 4.5 μm.

8. The method of claim 1, wherein the second depth is about 4 μm and the third depth is about 6.5 μm.

9. The method of claim 1, wherein the ion fluence in the first region is in the range of from about 0.01 to about 0.05 atomic %.

10. The method of claim 1, wherein the ion fluence in the second region is about 0.15 atomic %.

11. The method of claim 1, wherein the solid electrolyte material is selected from the group consisting of: Li₇La₃Zr₂O₁₂ (LLZO), Na₃Zr₂Si₂PO₁₂ (NASICON), Li₆PS₅Br, Li_{1.3}Al_{0.3}Ti_{1.7}(PO₄)₃ (LISICON), Li₃PO₄, and Li_{2.94}PO_{3.50}N_{0.31} (LIPON).

12. A modified solid electrolyte material having residual compressive stress introduced to a surface region thereof, comprising:
a solid electrolyte material having a first surface;
a first region within the solid electrolyte material extending from the first surface to a first depth, the first region having a first ion fluence; and
a second region within the solid electrolyte material extending from a second depth to a third depth, the second region having a second ion fluence
wherein the second ion fluence is larger than the first ion fluence.

13. The modified solid electrolyte material of claim 12, wherein the solid electrolyte material is selected from the group consisting of: Li₇La₃Zr₂O₁₂ (LLZO), Na₃Zr₂Si₂PO₁₂ (NASICON), Li₆PS₅Br, Li_{1.3}Al_{0.3}Ti_{1.7}(PO₄)₃ (LISICON), Li₃PO₄, and Li_{2.94}PO_{3.50}N_{0.31} (LIPON).

14. The modified solid electrolyte material of claim 12, wherein the first depth is about 1 μm.

15. The modified solid electrolyte material of claim 12, wherein the second depth is within a range of from about 2.5 μm to about 3.5 μm and the third depth is within a range of from about 4 μm to about 4.5 μm.

16. The modified solid electrolyte material of claim 12, wherein the second depth is about 4 μm and the third depth is about 6.5 μm.

17. The modified solid electrolyte of claim 12, wherein the ion fluence in the first region is in the range of from about 0.01 to about 0.05 atomic %.

18. The modified solid electrolyte of claim 12, wherein the ion fluence in the second region is about 0.15 atomic %.
